(19) United States
(12) Patent Application Publication
(10) Pub. No.: US 2022/0173964 A1
(43) Pub. Date: Jun. 2, 2022

(54) SYSTEM AND METHOD FOR SETTING INFORMATION ON WIRELESS COMMUNICATION

(71) Applicant: Hitachi, Ltd., Tokyo (JP)

(72) Inventors: Tomoyuki IIJIMA, Tokyo (JP); Masayuki TAKASE, Tokyo (JP); Takashi YOKOYAMA, Tokyo (JP); Masato HIMENO, Tokyo (JP)

(73) Assignee: Hitachi, Ltd., Tokyo (JP)

(21) Appl. No.: 17/521,558

(22) Filed: Nov. 8, 2021

(30) Foreign Application Priority Data
Nov. 30, 2020 (JP) 2020-198830

(51) Int. Cl. H04L 12/24; H04W 24/02

(52) U.S. Cl. CPC H04L 41/0803; H04W 24/02

(57) ABSTRACT

An information setting system includes a representative setting device and a remote setting device in a wireless communication facility. The remote setting device manages remote management information including information indicating a correspondence relationship among a device identifier, a device name, and a setting object. The representative setting device acquires a device identifier, allocates a network identifier to the device, stores the acquired device identifier and the allocated network identifier, and transmits the device identifier to the remote setting device. The remote setting device specifies a device name and a setting object from the remote management information based on the device identifier, and transmits the device name and the setting object to the representative setting device. The representative setting device sets information conforming to the setting object to the device to which the network identifier is allocated, based on the device identifier and the network identifier corresponding to the device name.

### INCORPORATION BY REFERENCE

This application claims priority based on Japanese patent application, No. 2020-198830 filed on Nov. 30, 2020, the entire contents of which are incorporated herein by reference.

### BACKGROUND

The present invention generally relates to setting of information on wireless communication.

Use of wireless communication is expanding. Introduction of a communication system of 5/6G (5th or 6th generation) achieves wireless communication capable of higher speed, lower delay, and multiple simultaneous connections. Attempts have also been made by companies and local governments to independently construct such wireless communication networks. By independently constructing a wireless communication network, a high-quality wide-area wireless communication network can be exclusively used without being affected by an external environment such as a decrease in communication quality due to congestion of a public wireless communication network, for example.

Wireless communication networks have been conventionally constructed and operated by communications operators using advanced technologies. Therefore, even if a company or a local government constructs and operates an independent wireless communication network, the company or the local government cannot do so completely on its own. The company or the local government requires the communications operator to not only provide the company or the local government with a wireless communication facility (wireless base station, packet relay device, network setting device, and the like), which is a device that realizes a wireless communication network but also provide a service for supporting the construction and operation of the wireless communication facility. JP 2010-239349 A and JP 2008-118296 A disclose technologies related to information setting, and Petri Ahokangs, MarjaMatinmikko-Blue, Seppo Yrjola, Veikko Seppanen “Business Models for Local 5G Micro Operators”, IEEE Transactionson Cognitive Communications and Networking, Vol. 5, No. 3, September 2019, Pages 730-740, <https://ieeexplore.ieee.org/document/8610462>discloses a role of communications operators to be assumed when a company or a local government independently constructs a wireless communication network.

### SUMMARY

When the communications operator provides a wireless communication facility to a company or a local government and the company or the local government independently constructs and operates each device, it is preferable to facilitate these works. This is because, in a case where these devices are installed outside a facility owned by the communications operator, for example, on the premise of the company or the local government, it increases the cost to cause a large number of engineers to visit the place and to work for a long time.

JP 2010-239349 A discloses a technique for causing a remote terminal to acquire a setting file including a local IP address to be allocated to an in-door unit. By applying this, when the communications operator installs the wireless communication facility outside the owned facility, it is possible to remotely set the range of the IP address allocated to each device. However, each device in the wireless communication facility does not necessarily become able to perform communication even if only an IP address within a specific range is allocated. This is because, since the communication network has a configuration in which a plurality of devices cooperate with one another, address setting in consideration of setting depending on setting contents of other devices is required.

JP 2008-118296 A discloses remote automatic setting using initial setting information. By applying this, the communications operator can register the initial setting items of each device in advance in the database of the management device, and remotely set the initial setting items to each device at the timing when the management device detects the activation of each device. However, it is not necessarily possible to register in advance all the initial setting items of each device of the wireless communication facility. For example, setting items such as a local IP address that is arbitrarily dispensed in the network of the installation place cannot be registered in advance. It is troublesome for the communications operator to grasp one by one the types, the number of devices, and setting contents that are different for each wireless communication facility and register them in advance.

Such a problem may occur in settings (e.g., settings related to a device that implements a wireless communication network in accordance with private LTE) related to wireless communication other than wireless communication in accordance with 5/6G.

An object of the present invention is to facilitate setting of a device in a wireless communication facility.

A representative example of the invention disclosed in the present application is as follows.

A wireless communication facility includes a representative setting device. An information setting system includes the representative setting device in the wireless communication facility and a remote setting device of the wireless communication facility. The wireless communication facility is a device package including a plurality of devices including one or more switch devices and a wireless base station. The representative setting device is not included in the plurality of devices in the wireless communication facility and is connected to at least one of the one or more switch devices.

The remote setting device manages remote management information that is information including information indicating a correspondence relationship among a device identifier, a device name, and a setting object. The device identifier is an identifier of a device. The device name is a name of the device. The setting object is an object representing information set in the device.

The representative setting device acquires a device identifier of each of a plurality of devices, allocates a network identifier to the device, includes the acquired device identifier and the allocated network identifier into representative management information that is information indicating a correspondence relationship between the device identifier and the network identifier, and transmits the device identifier to the remote setting device. The remote setting device receives the device identifier for each of the plurality of devices, specifies the device name and the setting object from the remote management information based on the device identifier, and transmits the device name and the setting object to the representative setting device. The representative setting device receives the device name and the setting object for each of the plurality of devices, and sets information conforming to the setting object to the device to which the network identifier is allocated, based on the device identifier and the network identifier corresponding to the device name in the representative management information.

According to an aspect of the present invention, information setting to a device in a wireless communication facility is facilitated.

The details of one or more implementations of the subject matter described in the specification are set forth in the accompanying drawings and the description below. Other features, aspects, and advantages of the subject matter will become apparent from the description, the drawings, and the claims

### BRIEF DESCRIPTION OF THE DRAWINGS

FIG. 1 is a block diagram illustrating an example of a configuration of an overall system according to an embodiment of the present invention;

FIG. 2 is a block diagram illustrating an example of a configuration of a representative setting device;

FIG. 3 is a block diagram illustrating an example of a configuration of a remote setting device;

FIG. 4 is a diagram illustrating an example of a sequence of setting a device in a wireless communication facility in response to an inquiry to the remote setting device made by the representative setting device;

FIG. 5 is a table presenting an example of a device identifier storage region of the representative setting device;

FIG. 6 is a table presenting an example of a device information storage region of the remote setting device;

FIG. 7 is a diagram illustrating an example of a facility configuration file stored in a facility configuration file storage region of the remote setting device;

FIG. 8 is a diagram illustrating an example of a facility configuration file stored in a facility configuration file storage region of the representative setting device;

FIG. 9 is a diagram illustrating an example of a device setting file stored in a device setting file storage region of the remote setting device;

FIG. 10 is a diagram illustrating an example of a device setting file stored in a device setting file storage region of the representative setting device;

FIG. 11 is a diagram illustrating an example of a flowchart of processing in which a facility configuration file creation unit of the representative setting device creates a facility configuration file;

FIG. 12 is a diagram illustrating an example of a flowchart of processing in which a device setting file creation unit of the representative setting device creates a device setting file;

FIG. 13 is a view illustrating an example in which information stored in the device information storage region of the remote setting device is displayed on a display screen;

FIG. 14 is a diagram illustrating an example of a sequence of setting information in a device in the wireless communication facility in response to input to the remote setting device by an operator;

FIG. 15 is a diagram illustrating an example of a sequence of setting information in a device in the wireless communication facility in response to an analysis result of data transmitted by a sensor;

FIG. 16 is a table presenting an example of a sensor information storage region of the remote setting device; and

FIG. 17 is a diagram illustrating an example of an outline of an information setting system.

### DESCRIPTION OF THE EMBODIMENTS

In the following description, the “interface device” may be one or more interface devices. The one or more interface devices may be at least one of the following. One or more input/output (I/O) interface devices. An input/output (I/O) interface device is an interface device for at least one of the I/O device and a remote display computer. The I/O interface device for the display computer may be a communication interface device. The at least one I/O device may be any of a user interface device, e.g., an input device such as a keyboard and a pointing device, and an output device such as a display device. □One or more communication interface devices. The one or more communication interface devices may be one or more communication interface devices of the same type (e.g., one or more network interface cards (NIC)) or two or more communication interface devices of different types (e.g., an NIC and a host bus adapter (HBA)).

In the following description, the “memory” is one or more memory devices that are an example of one or more storage devices, and may typically be a main storage device. The at least one memory device in the memory may be a volatile memory device or a nonvolatile memory device.

In the following description, the “persistent storage device” may be one or more persistent storage devices that are an example of one or more storage devices. The persistent storage device may typically be a nonvolatile storage device (e.g., an auxiliary storage device), and specifically may be, for example, a hard disk drive (HDD), a solid state drive (SSD), a non-volatile memory express (NVME) drive, or a storage class memory (SCM).

In the following description, the “storage device” may be at least a memory of a memory and a persistent storage device.

In the following description, the “processor” may be one or more processor devices. The at least one processor device may typically be a microprocessor device such as a central processing unit (CPU), but may also be another type of processor device such as a graphics processing unit (GPU). The at least one processor device may be single-core or multi-core. The at least one processor device may be a processor core. The at least one processor device may be a processor device in a broad sense such as a circuit (e.g., a field-programmable gate array (FPGA), a complex programmable logic device (CPLD), or an application specific integrated circuit (ASIC)) that is an aggregate of gate arrays in a hardware description language for performing a part or the entirety of processing.

In the following description, information from which an output is obtained with respect to an input may be described with an expression such as “xxx table”, but the information may be data having any structure (e.g., it may be structured data or unstructured data), or may be a learning model represented by a neural network, a genetic algorithm, or a random forest that generates an output with respect to an input. Therefore, “xxx table” can be referred to as “xxx information”. In the following description, the configuration of each table is an example, and one table may be divided into two or more tables, or the entirety or a part of two or more tables may be one table.

In the following description, there is a case where processing is described with “program” as a subject, but the subject of the processing may be a processor (alternatively, a device such as a controller having the processor) because by being executed by the processor, the program performs determined processing while appropriately using a storage device and/or an interface device. The program may be installed from a program source to a device such as a computer. The program source may be, for example, a program distribution server having a non-transitory recording device connected to a network or a computer-readable (e.g., a non-transitory) recording medium. In the following description, two or more programs may be implemented as one program, or one program may be implemented as two or more programs. Since the function is exerted by execution of the program, the “xxx program” may be referred to as “xxx unit”. At least a part of the processing performed by “xxx unit” may be implemented by hardware.

In the following description, in a case where the same kind of elements are explained without distinction, common reference numerals among the reference numerals may be used, and in a case where the same kind of elements are distinguished, reference numerals may be used.

In the following description, the “file” may be an example of an object. The “object” is one block of logical electronic data viewed from a program such as an application program.

An embodiment of the present invention will be described below with reference to the drawings.

### (A1) Configuration of Overall System

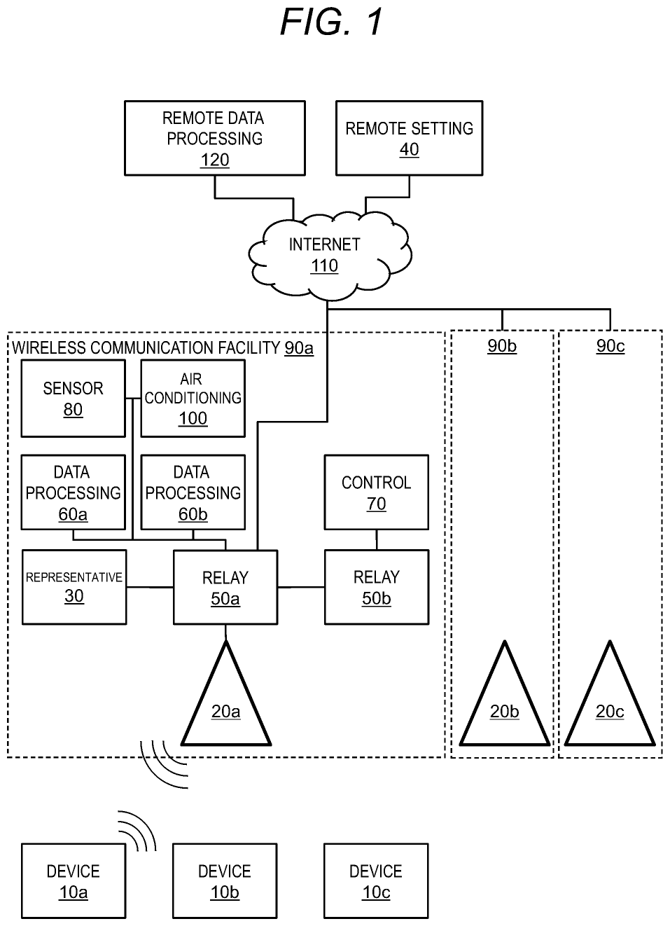

FIG. 1 is a block diagram illustrating an example of the configuration of the overall system according to an embodiment of the present invention.

It includes a wireless communication facility 90 (e.g., 90a to 90c) provided to a company or a local government (an example of a provision destination of the wireless communication facility 90), a remote setting device 40 of the wireless communication facility 90, and a remote data processing device 120 of the wireless communication facility 90. The wireless communication facility 90 (e.g., 90a) includes a packet relay device 50 (e.g., 50a and 50b). The packet relay device 50, the remote data processing device 120, and the remote setting device 40 in the wireless communication facility 90 are connected to an Internet 110 (an example of a communication network).

A wireless communication device 10 (e.g., wireless communication devices 10a to 10c in a certain company) that performs wireless communication exists in a company or a local government. Here, examples of the wireless communication device 10 include a robot that operates in a factory, an unmanned transport vehicle, a wireless device such as a sensor, a tablet personal computer (PC), and a smartphone. The wireless communication device 10 wirelessly communicates with a device (e.g., a data processing device 60) in the wireless communication facility 90 through a wireless base station 20, and exchanges data such as text, audio, and video.

The wireless communication facility 90 includes one or more wireless base stations 20, a representative setting device 30, one or more packet relay devices 50, one or more data processing devices 60, a base station control device 70, one or more sensors 80, and one or more air conditioning devices 100. The packet relay device 50 is an example of a switch device. Each of the packet relay device 50, the data processing device 60, and the base station control device 70 is an example of any of a plurality of devices (each of the plurality of devices is a device in which information can be set based on a setting file from the remote setting device 40) in the wireless communication facility 90. The wireless base station 20 wirelessly communicates with the wireless communication device 10 in accordance with a high-speed wireless communication standard of 5G/6G typically (alternatively, it may be a wireless communication standard such as Wi-Fi (registered trademark) or Long Term Evolution (LTE)), and exchanges data such as text, audio, and video. The wireless base station 20 is connected to the packet relay device 50 by wire, and transmits data received from the wireless communication device 10 to the packet relay device 50 and transmits data received from the packet relay device 50 to the wireless communication device 10.

The packet relay device 50 transmits a packet (data) received from the wireless base station 20 to the data processing device 60 in the wireless communication facility 90 and the remote data processing device 120 via the Internet 110.

The base station control device 70 carries out identification of the wireless communication device 10 and control of the wireless base station.

The data processing device 60 is, for example, a server device, performs processing on data received from the wireless communication device 10, and returns the result. The data processing device 60 may perform processing that is not permitted to take time on the data received from the wireless communication device 10. On the other hand, the remote data processing device 120 may perform processing that is permitted to take time on the data received from the wireless communication device 10.

The representative setting device 30 is connected to the packet relay device 50 by wire, and carries out setting related to a network configuration of a device in the wireless communication facility 90 and each device. A procedure of setting of information for the device will be described later. The representative setting device 30 communicates with the remote setting device 40, acquires a setting file managed by the remote setting device 40, and, based on the setting file, sets information to a device in the wireless communication facility 90 to which the representative setting device 30 itself belongs.

The sensor 80 outputs a value (e.g., a value of temperature) measured for a predetermined measurement target (e.g., the data processing device 60) in the wireless communication facility 90. The air conditioning device 100 performs air conditioning in the wireless communication facility 90.

The configuration, type, and number of the wireless communication device 10, the wireless base station 20, the representative setting device 30, the packet relay device 50, the data processing device 60, the base station control device 70, the sensor 80, and the air conditioning device 100 are not limited to the example illustrated in FIG. 1, and may be made as another mode as appropriate.

### (A2) Configuration of Representative Setting Device 30

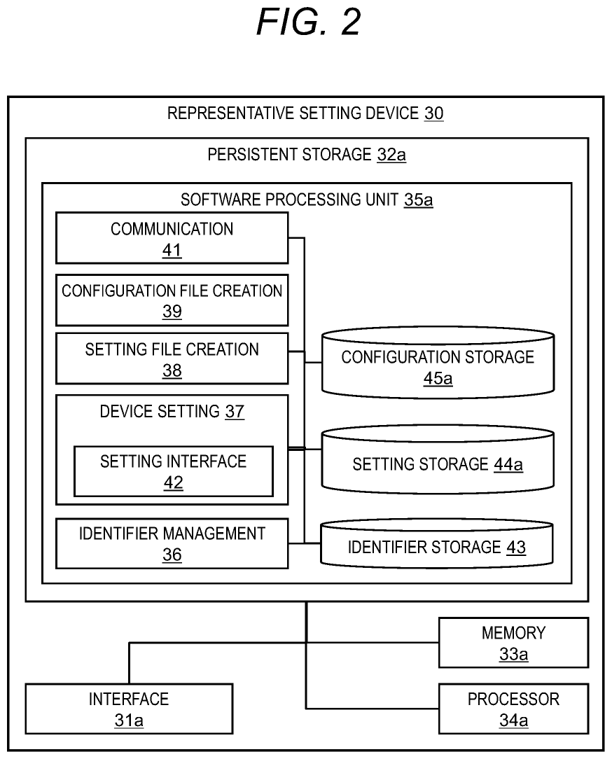

FIG. 2 is a block diagram illustrating an example of the configuration of the representative setting device 30.

The representative setting device 30 includes an interface device (e.g., a packet transmission/reception port) 31a, a persistent storage device 32a, a memory 33a, and a processor 34a connected thereto.

The interface device 31a is connected to, for example, the packet relay device 50.

The persistent storage device 32a stores some or all of programs of a software processing unit 35a, setting information necessary for operation of the programs, and the like. When the representative setting device 30 operates, at least a program necessary for the operation is read into the memory 33a. By executing a program read into the memory 33a, the processor 34a executes the processing of the representative setting device 30. The memory 33a may include a program execution environment such as an operating system (OS) that is not illustrated, or may include data that the processor 34a temporarily reads and writes.

The software processing unit 35a includes a device identifier management program 36, a device setting program 37, a device setting file creation program 38, a facility configuration file creation program 39, and a remote setting device communication program 41. The device setting program 37 has an interface function 42 (e.g., an interface function for each device name) for the device. Each program is executed by the processor 34a to exhibit the function of the software processing unit 35a. The software processing unit 35a manages a device identifier storage region 43, a device setting file storage region 44a, and a facility configuration file storage region 45a.

### (A3) Configuration of Remote Setting Device 40

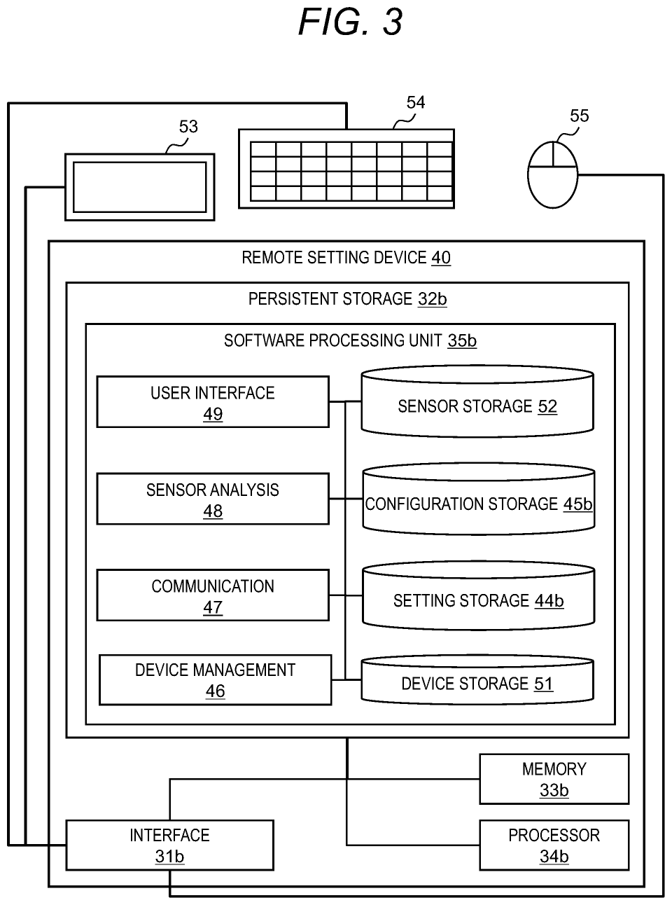

FIG. 3 is a block diagram illustrating an example of the configuration of the remote setting device 40.

The remote setting device 40 has an interface device (e.g., a packet transmission/reception port) 31b, a persistent storage 32b, a memory 33b, and a processor 34b connected thereto.

The interface device 31b is connected to, for example, the Internet 110. The interface device 31b is connected to an input device (e.g., a keyboard 54 and a mouse 55) and a display device 53. The input device and the display device 53 may be an integrated device such as a touchscreen.

The persistent storage device 32b stores some or all of programs of a software processing unit 35b, setting information necessary for operation of the programs, and the like. When the remote setting device 40 operates, at least a program necessary for the operation is read into the memory 33b. By executing a program read into the memory 33b, the processor 34b executes the processing of the remote setting device 40.

The software processing unit 35b includes a device information management program 46, a representative setting device communication program 47, a sensor information analysis program 48, and a user interface program 49. Each program is executed by the processor 34b to exhibit the function of the software processing unit 35b. The software processing unit 35b manages a device information storage region 51, a device setting file storage region 44b, a facility configuration file storage region 45b, and a sensor information storage region 52.

The user interface program 49 receives input of data associated with a device, a device setting file, and a facility configuration file from an operator (operator of the wireless communication network) who operates the keyboard 54 and the mouse 55, and stores those data and files in a corresponding region of the device information storage region 51, the device setting file storage region 44b, and the facility configuration file storage region 45b. When receiving a reference request for data associated with a device from the operator operating the keyboard 54 and the mouse 55, the user interface program 49 acquires data stored in the device information storage region 51 and outputs the acquired data to the display device 53.

### (A4) Operation Sequence between Representative Setting Device 30 and Remote Setting Device 40 in Response to Activation of Representative Setting Device 30

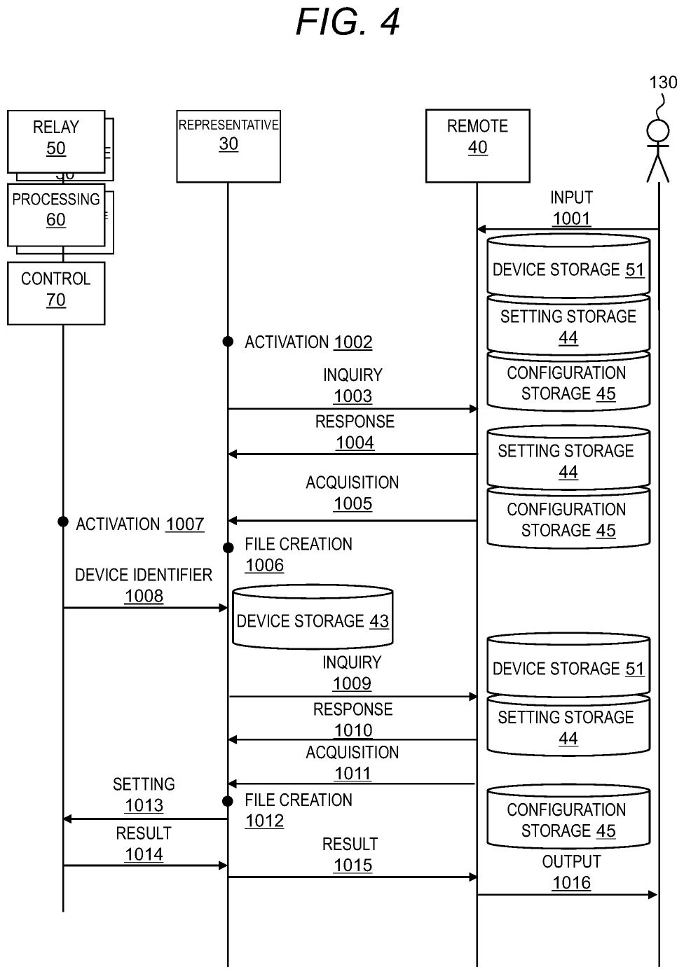

FIG. 4 is a diagram illustrating an example of the operation sequence between the representative setting device 30 and the remote setting device 40 in response to activation of the representative setting device 30.

When receiving (1001) input of data associated with a device, a device setting file, and a facility configuration file from an operator 130 of the wireless communication network, the user interface program 49 of the remote setting device 40 writes the data associated with the device, the device setting file, and the facility configuration file into the device information storage region 51, the device setting file storage region 44, and the facility configuration file storage region 45, respectively. The format of data stored in the device information storage region 51, the device setting file storage region 44, and the facility configuration file storage region 45 will be described later.

When the representative setting device 30 is activated (1002), the remote setting device communication program 41 inquires of the remote setting device 40 about the identifier of the wireless communication facility 90 to which the representative setting device 30 itself belongs, using the device identifier of the representative setting device 30 itself as a key (1003). Examples of the device identifier include a MAC address and a serial number of the device. At this time, the remote setting device communication program 41 also inquires about the presence or absence of a device setting file defining setting contents (information to be set).

Upon receiving the inquiry from the representative setting device 30, the representative setting device communication program 47 of the remote setting device 40 searches the device information storage region 51 using the device identifier as a key, and specifies the facility identifier to which the representative setting device 30 belongs and the device name. The representative setting device communication program 47 specifies a device setting file corresponding to the device name. Thereafter, the representative setting device communication program 47 of the remote setting device 40 responds with the facility identifier to which the representative setting device 30 belongs, a facility configuration file name, the device name, and the device setting file name (1004). Upon acquiring the facility configuration file name and the setting file name, the remote setting device communication program 41 of the representative setting device 30 acquires the facility configuration file and the device setting file (1005). The remote setting device communication program 41 of the representative setting device 30 stores the facility configuration file into the facility configuration file storage region 45 and stores the device setting file into the device setting file storage region 44.

The device identifier management program 36 of the representative setting device 30 recognizes a correspondence relationship between the device name acquired above and an identifier for identifying itself at the time of communication. Examples of the communication identifier for identifying the device at the time of communication include an IP address. A case where an IP address is used as the communication identifier will be described below in detail. Upon recognizing the correspondence relationship between the device name and the IP address, the device identifier management program 36 of the representative setting device 30 refers to the facility configuration file, and, in a case where its own device name is described in the file, adds the corresponding IP address to the corresponding location of the file. Due to this, the IP address is associated with the device name. Similarly, the device identifier management program 36 refers to the device setting file, and, in a case where its own device name is described, adds the corresponding IP address. Thus, the facility configuration file and the device setting file are created in accordance with the environment of the wireless communication facility 90 (1006). Then, the device setting program 37 performs its own setting in accordance with the procedure described in the device setting file. A specific creation procedure of the facility configuration file and the device setting file will be described later.

When the data processing device 60, the packet relay device 50, or the base station control device 70 in the wireless communication facility 90 is activated (1007), the representative setting device 30 recognizes the device identifier of each of these devices 60, 50, and 70 because they are in a same network segment (1008). Upon recognizing the device identifier of the device of each of the data processing device 60, the packet relay device 50, and the base station control device 70, the device identifier management program 36 of the representative setting device 30 allocates an IP address to the device and stores the correspondence relationship between the device identifier and the IP address into the device identifier storage region 43.

Next, the remote setting device communication program 41 of the representative setting device 30 inquires of the remote setting device 40 about the device name of this device, using the device identifier of this device and the facility identifier to which this device belongs as keys (1009). At this time, the remote setting device communication program 41 also inquires about the presence or absence of a device setting file corresponding to the device name.

Upon receiving the inquiry from the representative setting device 30, the representative setting device communication program 47 of the remote setting device 40 searches the device information storage region 51 using the device identifier as a key, and specifies the device name. The representative setting device communication program 47 specifies a device setting file defining setting contents. Thereafter, the representative setting device communication program 47 of the remote setting device 40 responds with the device name and the device setting file name (1010). Upon acquiring the device setting file name, the remote setting device communication program 41 of the representative setting device 30 acquires the device setting file corresponding to the file name (1011). Then, the remote setting device communication program 41 of the representative setting device 30 stores the device setting file into the device setting file storage region 44.

Next, the remote setting device communication program 41 of the representative setting device 30 searches the device identifier storage region 43 using the device name acquired from the remote setting device 40 as a key, and recognizes the corresponding IP address. Then, the facility configuration file creation program 39 of the representative setting device 30 refers to the facility configuration file, and, in a case where the acquired device name is described, adds the corresponding IP address. Similarly, the device setting file creation program 38 of the representative setting device 30 refers to the device setting file, and, in a case where the acquired device name is described, adds the corresponding IP address. Thus, the facility configuration file and the device setting file are created in accordance with the environment of the wireless communication facility (1012). A specific creation procedure of the facility configuration file and the device setting file will be described later.

Subsequently, the device setting program 37 of the representative setting device 30 performs setting of information for the data processing device 60, the packet relay device 50, and the base station control device 70 in accordance with the procedure described in the device setting file (1013). After performing the setting, the device setting program 37 of the representative setting device 30 receives the result (1014). The remote setting device communication program 41 of the representative setting device 30 further notifies the remote setting device 40 of the result (1015). Upon receiving the result, the representative setting device communication program 47 of the remote setting device 40 stores the result into the device information storage region 51. The operator 130 of the wireless communication network can check the result stored in the device information storage region 51 by outputting the result to the display device 53 (1016).

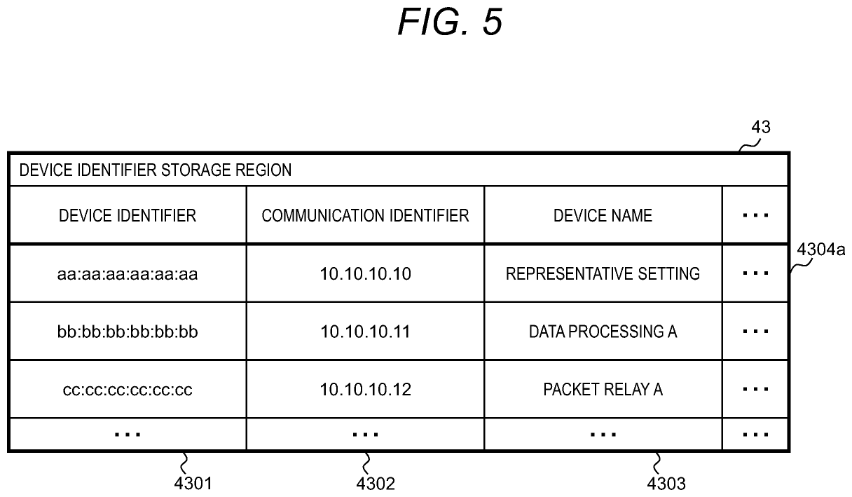

FIG. 5 is an example of the device identifier storage region 43 held by the representative setting device 30.

The information stored in the device identifier storage region 43 includes an entry 4304 for each device. The entry 4304 includes information such as a device identifier 4301, a communication identifier 4302, and a device name 4303. For example, an entry 4304a indicates that device identifier management program 36 of representative setting device 30 has allocated a communication identifier “10.10.10.10” to a device having a device identifier “aa:aa:aa:aa:aa:aa”, and the device information management program 46 of remote setting device 40 has defined a device name “representative setting”. Here, the “device name” may be a name of the packet relay device, the data processing device, the sensor, or other various devices themselves or a name of the type of the device (packet relay device, data processing device, and the like).

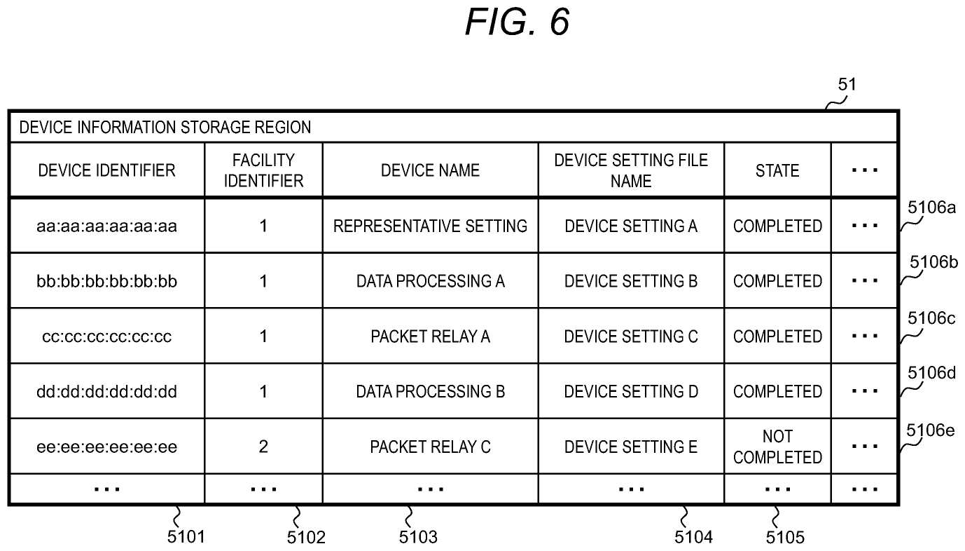

FIG. 6 is an example of the device information storage region 51 held by the remote setting device 40.

The information stored in the device information storage region 51 includes an entry 5106 for each device. The entry 5106 includes information such as a device identifier 5101, a facility identifier 5102, a device name 5103, a device setting file name 5104, and a state 5105. For example, an entry 5106a indicates that the device with the device identifier “aa:aa:aa:aa:aa:aa” belongs to the wireless communication facility 90 with the facility identifier “1”, the device name is “representative setting”, the device setting file name is “device setting A”, and the setting state is “completed”.

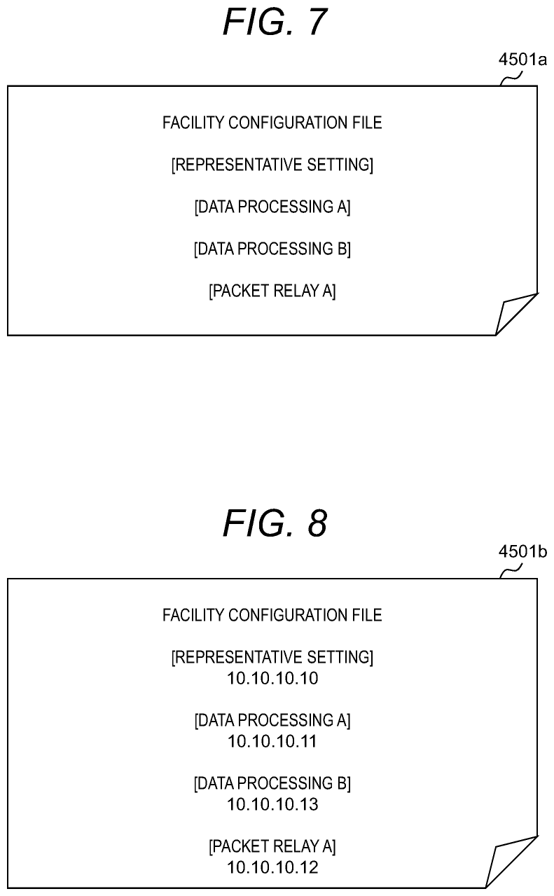

FIG. 7 is an example of a facility configuration file 4501a stored in the facility configuration file storage region 45b of the remote setting device 40.

In the facility configuration file 4501a, the device name that becomes a setting target in the facility is defined. For example, in the case of the facility configuration file 4501a, it is indicated that “representative setting”, “data processing A” (data processing device 60a), “data processing B” (data processing device 60b), and “packet relay A” (packet relay device 50a) are set in this facility.

FIG. 8 is an example of a facility configuration file 4501b stored in the facility configuration file storage region 45a of the representative setting device 30.

The facility configuration file 4501b is a file created by associating the IP address stored in the device identifier storage region 43 with the location of the device name described in the facility configuration file 4501a acquired from the remote setting device 40 by the representative setting device 30. For example, in a case where the representative setting device 30 refers to the facility configuration file 4501a acquired from the remote setting device 40 and “data processing A” is described, the representative setting device 30 searches the device identifier storage region 43 and describes the IP address “10.10.10.11” associated with the device name “data processing A”. Similarly, the IP address “10.10.10.13” is described in “data processing B” of the facility configuration file 4501b, and “10.10.10.12” is described in “packet relay A”.

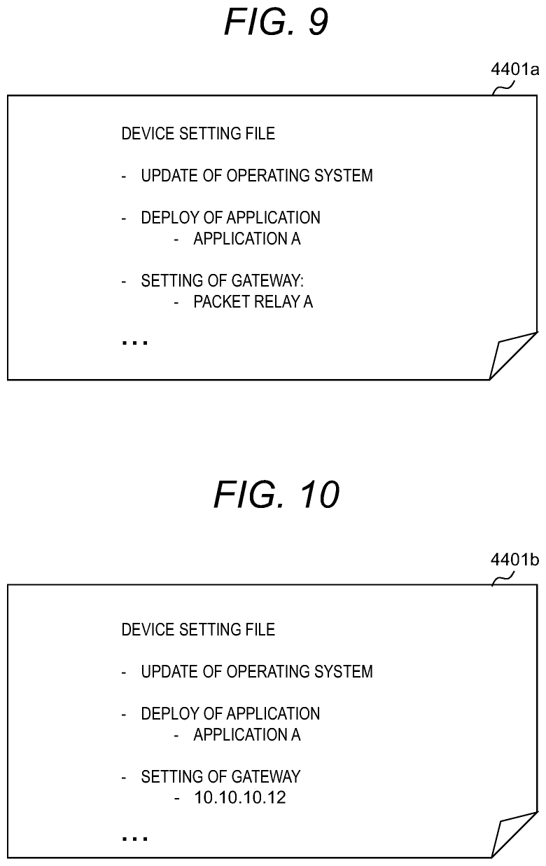

FIG. 9 is an example of a device setting file 4401a stored in the device setting file storage region 44b of the remote setting device 40.

In the device setting file 4401a, setting contents of the device are defined for each device set in the wireless communication facility 90. For example, in the setting file 4401a, it is defined so that the setting target device updates the operating system and deploys “application A”, and, further, the gateway sets “packet relay A”.

FIG. 10 is an example of a device setting file 4401b stored in the device setting file storage region 44a of the representative setting device 30.

The device setting file 4401b is a file created by associating the IP address stored in the device identifier storage region 43 with the location of the device name described in the device setting file 4401a acquired from the remote setting device 40 by the representative setting device 30. For example, in a case where the representative setting device 30 refers to the device setting file 4401a acquired from the remote setting device 40 and “packet relay A” is described, the representative setting device 30 searches the device identifier storage region 43 and describes the IP address “10.10.10.12” associated with the device name “packet relay A”.

### (A5) Operation Sequence of Representative Setting Device in Response to Activation of Device in Wireless Communication Facility 90

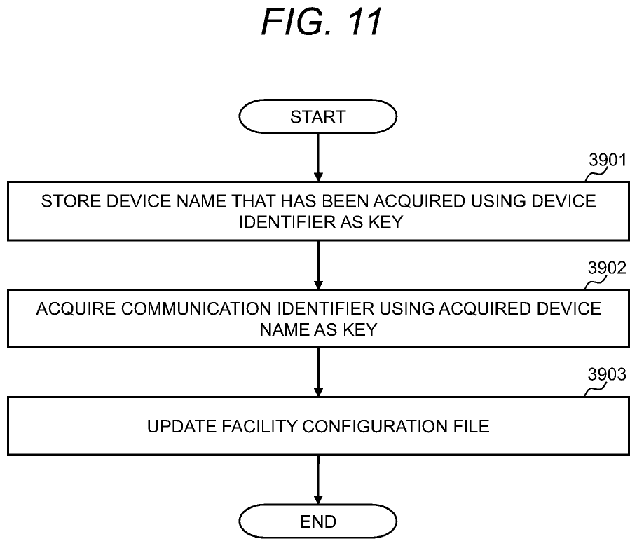

FIG. 11 is an example of the procedure of facility configuration file creation performed by the facility configuration file creation program 39 of the representative setting device 30.

When the representative setting device 30 recognizes that the device is activated in the wireless communication facility 90, the remote setting device communication program 41 inquires of the remote setting device 40 about the device name using the device identifier of the device as a key, and acquires the device name. The remote setting device communication program 41 stores the device name into the device identifier storage region 43 (3901). The facility configuration file creation program 39 in the representative setting device 30 searches the device identifier storage region 43 using the acquired device name as a key, and acquires the IP address of the device (3902). Finally, the facility configuration file creation program 39 refers to the facility configuration file 4501, describes the IP address corresponding to the location of the device name in the facility configuration file 4501, and updates the facility configuration file 4501 (3903).

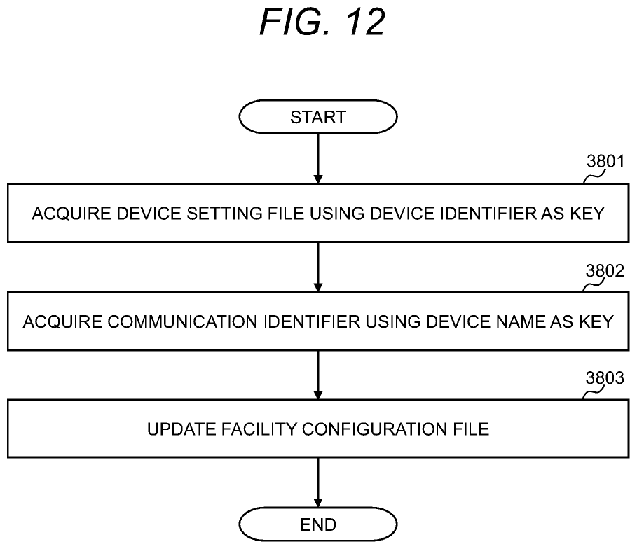

FIG. 12 is an example of the procedure of device setting file creation performed by the device setting file creation program 38 of the representative setting device 30.

When the representative setting device 30 recognizes that the device is activated in the wireless communication facility 90, the remote setting device communication program 41 inquires of the remote setting device 40 about the device setting file using the device identifier of the device as a key, and acquires the device setting file (3801). Upon acquiring the device setting file, the device setting file creation program 38 in the representative setting device 30 refers to the device setting file, searches the device identifier storage region 43 using the device name described in the device setting file as a key, and acquires the IP address of the device (3802). Finally, the device setting file creation program 38 describes the IP address corresponding to the location of the device name in the device setting file, and updates the device setting file (3803).

### (A6) Procedure for Displaying Result of Setting Wireless Communication Facility 90

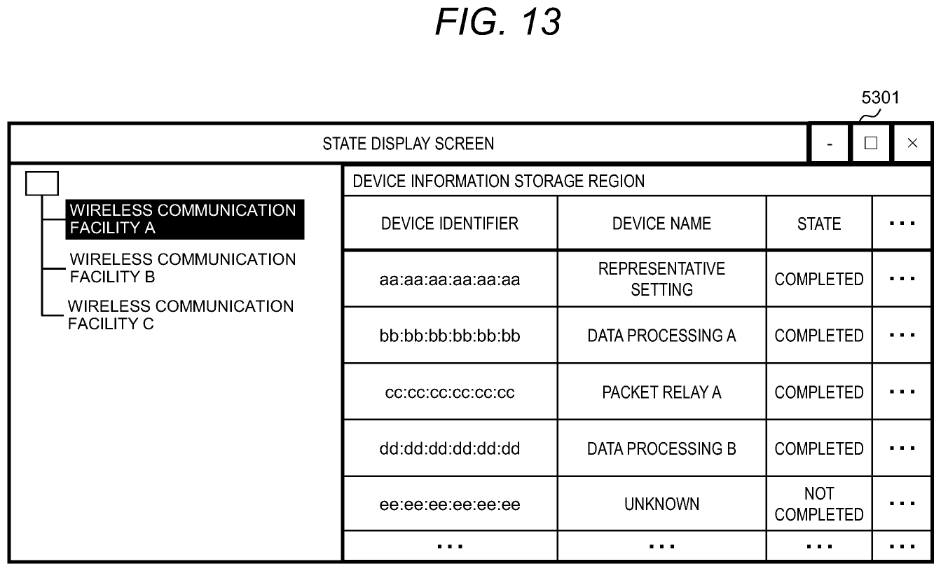

FIG. 13 illustrates an example of a screen displaying the state of the wireless communication facility.

A state display screen 5301 is a screen that presents a state in which the wireless communication facility is set for the operator 130 of the wireless communication network by the user interface program 49. The screen 5301 illustrated in FIG. 13 indicates, for example, the following. □“Representative setting” (representative setting device 30), “data processing A” (data processing device 60a), “packet relay A” (packet relay device 60a), and “data processing B” (data processing device 60b) belong to the wireless communication facility 90a, and these settings are completed. □The device with the device identifier “ee:ee:ee:ee:ee:ee” is activated but cannot be set and is “not completed” because the device name of the device is unknown.

### (B1) Operation Sequence between Representative Setting Device 30 and Remote Setting Device 40 in Response to input of Operator 130 of Wireless Communication Network

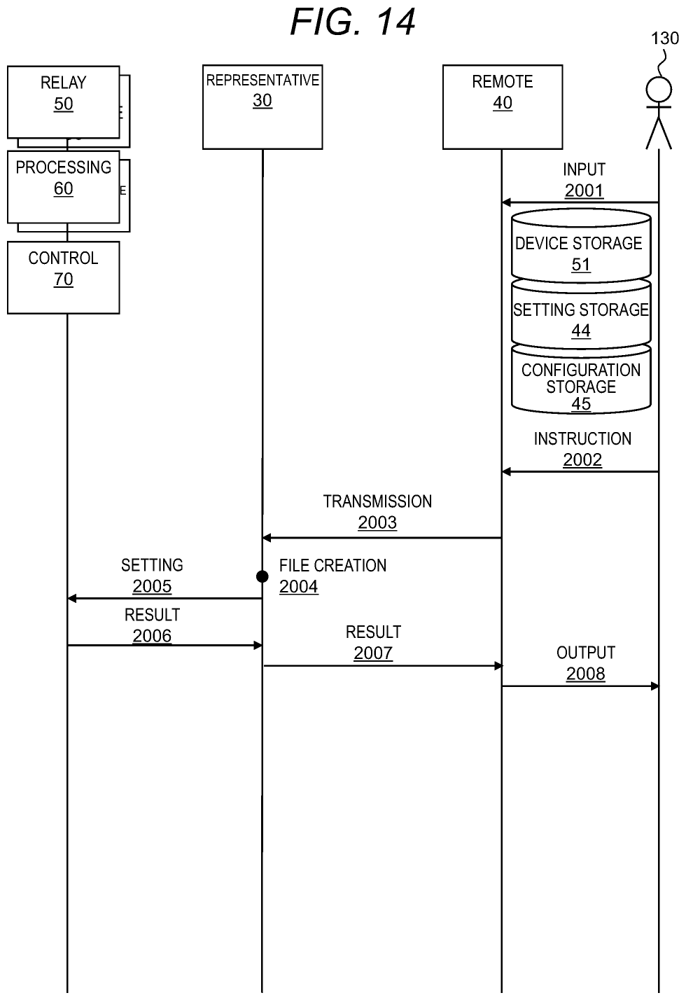

FIG. 14 is a diagram illustrating an example of an operation sequence between the representative setting device 30 and the remote setting device 40 in response to input of the operator 130 of the wireless communication network.

When receiving (2001) input of data associated with a device, a device setting file, and a facility configuration file from an operator 130 of the wireless communication network, the user interface program 49 of the remote setting device 40 writes the data associated with the device, the device setting file, and the facility configuration file into the device information storage region 51, the device setting file storage region 44, and the facility configuration file storage region 45, respectively.

When the operator 130 of the wireless communication network instructs execution of the contents input to the device setting file (2002), the remote setting device 40 transmits the written device setting file to the representative setting device 30 (2003). Upon receiving the device setting file, the representative setting device 30 stores the device setting file into the device setting file storage region 44a.

Next, the representative setting device 30 searches the device identifier storage region 43 using the device name described in the device setting file as a key, and recognizes the IP address of the device. Then, the representative setting device 30 adds the recognized IP address to the device setting file. Thus, the device setting file is created in accordance with the environment of the wireless communication facility (2004).

Subsequently, the representative setting device 30 performs setting of the data processing device 60, the packet relay device 50, and the base station control device 70 in accordance with the procedure described in the device setting file (2005). After the setting is performed, the representative setting device 30 receives the result (2006). The representative setting device 30 further notifies the remote setting device 40 of the result (2007). Upon receiving the result, the remote setting device 40 stores the result into the device information storage region 51. The operator 130 of the wireless communication network can check the result stored in the device information storage region 51 by outputting the result to the display device 53 (2008).

### (C1) Operation Sequence between Representative Setting Device 30 and Remote Setting Device 40 in Response to Analysis Result of Information Transmitted by Sensor 80

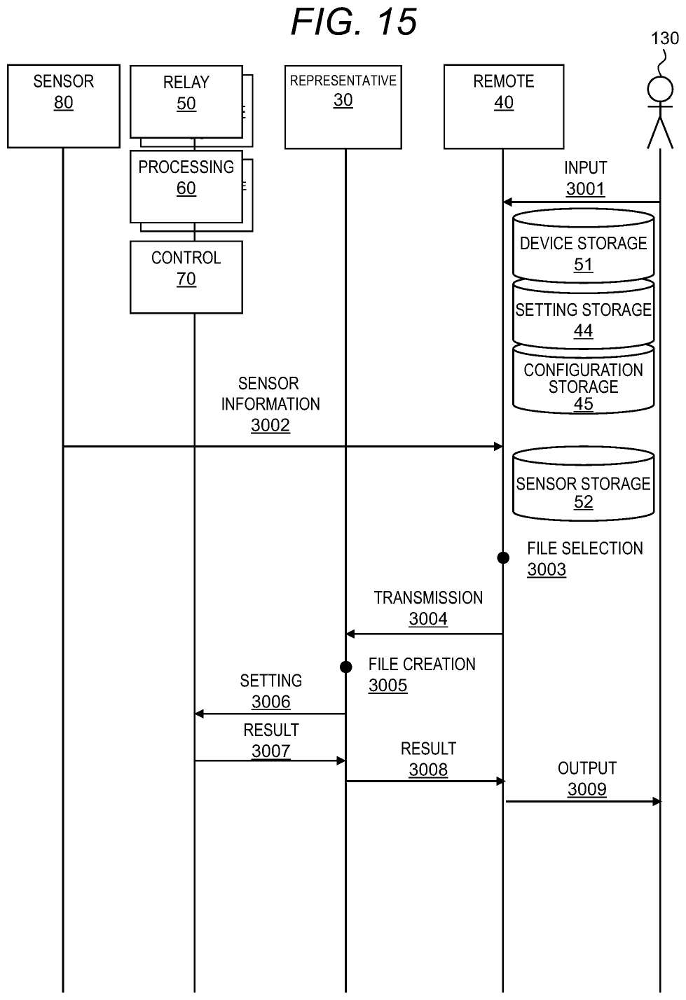

FIG. 15 is a diagram illustrating an example of an operation sequence between the representative setting device 30 and the remote setting device 40 in response to the analysis result of information transmitted by the sensor 80.

When receiving (3001) input of data associated with a device, a device setting file, and a facility configuration file from an operator 130 of the wireless communication network, the user interface program 49 of the remote setting device 40 writes the data associated with the device, the device setting file, and the facility configuration file into the device information storage region 51, the device setting file storage region 44, and the facility configuration file storage region 45, respectively. At this time, one or more device setting files may be created for one device. For example, it is possible to create a device setting file for performing setting of lowering the operating frequency of the packet relay device 50 or the data processing device 60, a device setting file for performing setting of reducing the operating program, and the like.

Upon receiving the information transmitted by the sensor 80 (3002), the remote setting device 40 stores the contents thereof into the sensor information storage region 52. The format of data stored in the sensor information storage region 52 will be described later.

The sensor information analysis program 48 in the remote setting device 40 refers to the information in the sensor information storage region 52, and, when detecting a change in the value of the sensor information, selects the device setting file registered in advance (3003). For example, when detecting that the value of the temperature of the temperature sensor increases, the sensor information analysis program 48 determines that the air conditioning device 100 of the wireless communication facility 90 is highly likely to have been broken down. Then, in order to prevent the packet relay device 50 and the data processing device 60 from being broken down due to heat, the sensor information analysis program 48 selects a device setting file for performing setting of lowering the operating frequency of the packet relay device 50 or the data processing device 60 or a device setting file for performing setting of reducing the program to operate. When the remote setting device 40 transmits its device setting file to the representative setting device 30 (3004), the representative setting device 30 stores the device setting file into the device setting file storage region 44a.

Next, the representative setting device 30 searches the device identifier storage region 43 using the device name described in the device setting file as a key, and recognizes the IP address of the device. Then, the representative setting device 30 adds the recognized IP address to the device setting file. Thus, the device setting file is created in accordance with the environment of the wireless communication facility (3005).

Subsequently, the representative setting device 30 performs setting of the data processing device 60, the packet relay device 50, and the base station control device 70 in accordance with the procedure described in the device setting file (3006). After performing the setting, the representative setting device 30 receives the result (3007). The representative setting device 30 further notifies the remote setting device 40 of the result (3008). Upon receiving the result, the remote setting device 40 stores the result into the device information storage region 51. The operator 130 of the wireless communication network can check the result stored in the device information storage region 51 by outputting the result to the display device 53 (3009).

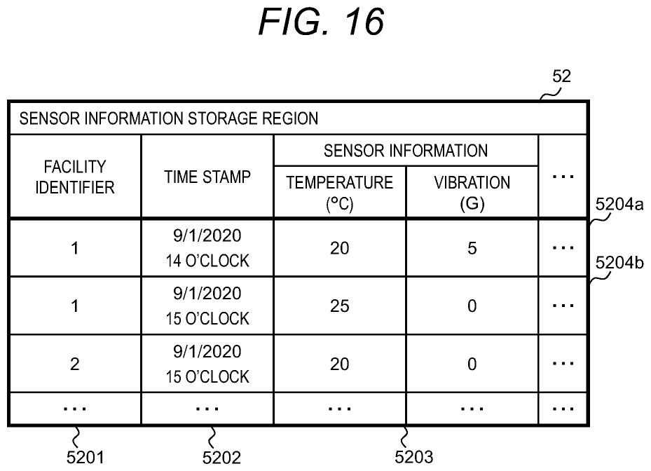

FIG. 16 is an example of the sensor information storage region 52 held by the remote setting device 40.

The information stored in the sensor information storage region 52 includes an entry 5204 for each set of facility and time. The entry 5202 includes information such as a facility identifier 5201, a time stamp 5202, and sensor information 5203. The sensor information 5203 includes, for example, information on a temperature sensor and information on a vibration sensor.

For example, the entry 5204a indicates the following. □The wireless communication facility 90 with the facility identifier “1” has a plurality of sensors such as a temperature sensor and a vibration sensor. □Sensor information including the value “20” of the temperature sensor and the value “5” of the vibration sensor was acquired at 14 o'clock on Sep. 1, 2020.

For example, the entry 5204b indicates the following. □In the wireless communication facility 90 with the facility identifier “1”, sensor information including the value “25” of the temperature sensor and the value “0” of the vibration sensor is acquired at 15 o'clock on Sep. 1, 2020.

In the processing described above, the representative setting device 30 creates the setting file of the device in the wireless communication facility in accordance with the environment of the facility. This can facilitate setting of each device constituting the wireless communication network. Then, the time required for setting can be reduced.

The present embodiment can be configured as a setting method or a computer program executed by the representative setting device 30, in addition to the configuration by the representative setting device 30. The computer program is preferably recorded on a computer-readable recording medium. As the recording medium, various media such as a floppy disk, a CD-ROM, a DVD-ROM, a magneto-optical disk, a memory card, and a hard disk can be used.

The present invention is not limited to the above-described embodiment, but includes various modifications and equivalent configurations within the gist of the scope of the accompanying patent claims. For example, the above-described embodiment has been described in detail for the purpose of explaining the present invention in an easy-to-understand manner, and the present invention is not necessarily limited to those including all the configurations described above. The configuration of a certain embodiment can be replaced partly by the configuration of another embodiment. The configuration of a certain embodiment may be added to the configuration of another embodiment. The configuration of each embodiment may partly be added to, deleted from, or replaced by another configuration.

A part or all of the above-described configurations, functions, processing units, processing means, and the like may be implemented by hardware by being designed as an integrated circuit or the like, or may be implemented by software by a processor interpreting and executing a program for implementing each function.

Information such as programs, tables, and files for implementing each function can be stored in a recording device such as a memory, a hard disk, and an SSD, or in a recording medium such as an IC card, an SD card, and a DVD.

Control lines and information lines that are considered necessary for the description are illustrated. Not necessarily all the control lines and information lines essential for implementation are illustrated. In reality, almost all the configurations may be considered mutually connected.

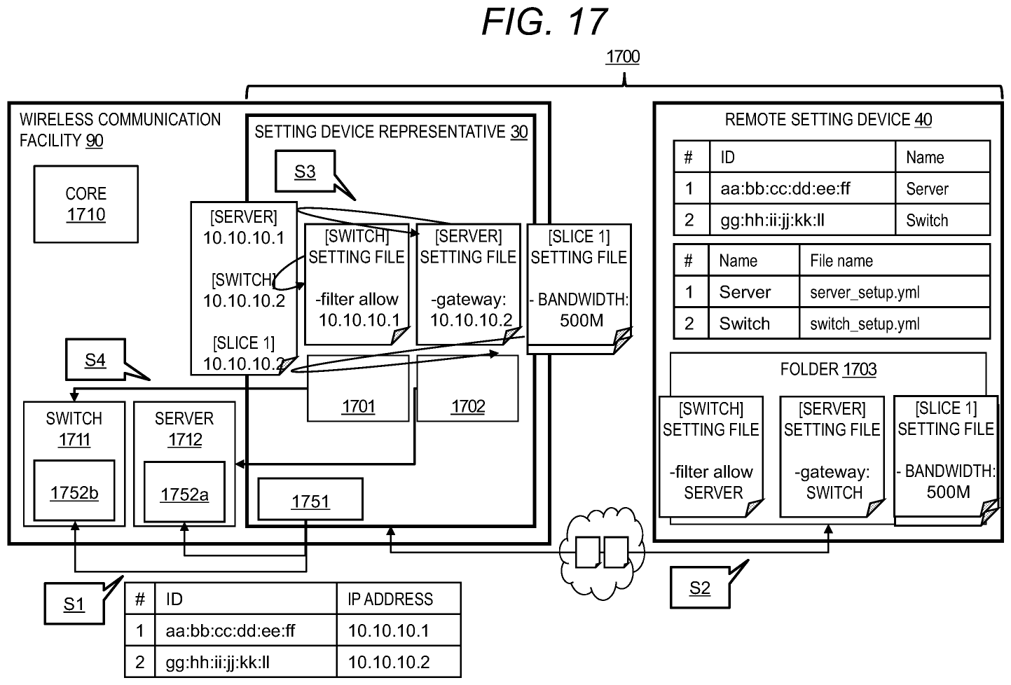

The above description can be summarized as follows with reference to FIG. 17, for example. The following description may include a description (e.g., a modification or another embodiment) not included in the above description. In the following description, the “setting file” is an example of a setting object, and may be a generic name for a facility configuration file and a device setting file, for example.

An information setting system 1700 includes the representative setting device 30 in the wireless communication facility 90 and the remote setting device 40 outside the wireless communication facility 90. The wireless communication facility 90 is a device package including a plurality of devices including one or more switch devices 1711 and a wireless base station. An example of the switch device 1711 is the above-described packet relay device 50. A server device 1712 illustrated is an example of the data processing device 60.

The representative setting device 30 has an interface function for each of the plurality of devices in the wireless communication facility 90. In the example of FIG. 17, the representative setting device 30 includes a switch IF 1701, which is an interface function for the switch device 1711, and a server IF 1702, which is an interface function for the server device 1712. The representative setting device 30 may include a core device 1710, which functions as a core network in 5G or LTE.

The remote setting device 40 manages remote management information, which is information including information indicating a correspondence relationship among the device identifier (e.g., MAC address), the device name, and the setting file. According to the example illustrated in FIG. 17, the remote management information includes information indicating the correspondence relationship between the device identifier (ID) and the device name (Name) and information indicating the correspondence relationship between the device name (Name) and the file name (setting file name). The device identifier is an identifier of a device. The device name is a name of a device (that may include the name of a device type). The setting file is a file representing information set in the device. The remote management information may include a plurality of setting files stored in a folder 1703 in a file system space of the remote setting device 40, for example.

In S1, the representative setting device 30 acquires a device identifier of each of a plurality of devices, allocates a network identifier to the device, includes the acquired device identifier and the allocated network identifier into representative management information that is information indicating a correspondence relationship between the device identifier and the network identifier.

In S2, the representative setting device 30 transmits the device identifier of each of the plurality of devices to the remote setting device 40. The remote setting device receives the device identifier for each of the plurality of devices, specifies the device name and the setting file from the remote management information based on the device identifier, and transmits the device name and the setting file to the representative setting device.

In S3 and S4, the representative setting device receives the device name and the setting file for each of the plurality of devices, and sets information conforming to the setting file to the device to which the network identifier is allocated, based on the device identifier and the network identifier corresponding to the device name in representative management information.

Thus, when the representative setting device 30 acquires the device identifier of each device, the setting file is acquired from the remote setting device 40 using the device identifier as a key, and the information is set in the device in the wireless communication facility 90 in accordance with the setting file. That is, information setting to the device in the wireless communication facility 90 is facilitated. The representative setting device 30 may include a dynamic host configuration protocol (DHCP) server 1751, each device may include a DHCP client 1752, and acquisition of the device identifier and allocation of the network identifier (e.g., IP address) may be performed by communication between the DHCP server 1751 and the DHCP client 1752. That is, the DHCP client 1752 may transmit the device identifier of the device having the DHCP client 1752 to the DHCP server 1751, and the DHCP server 1751 may determine a network identifier for the device identifier and transmit the determined network identifier to the DHCP client 1752.

At least one setting file managed by the remote setting device 40 may be an update setting file, which is a setting file including a device name with which a network identifier is associated. In a case where the setting file corresponding to the device identifier of a device is an update setting file, the representative setting device 30 may specify the network identifier corresponding to the device name in the update setting file from the representative management information, associate the specified network identifier with the device name in the update setting file, and set the information to the device in accordance with the update setting file with which the network identifier is associated. Due to this, information setting for communication between devices in the wireless communication facility 90 or communication via a device is easily and appropriately performed. According to the example illustrated in FIG. 17, the update setting file includes a setting file for the switch device 1711 and a setting file for the server device 1712. The setting file for the switch device 1711 managed by the remote setting device 40 includes the device name of the server device 1712 (an example of a connection device) permitted to communicate via the switch device 1711. The setting file for the switch device managed by the remote setting device 40 may include the device name of the server device 1712 in which communication via the switch device 1711 is prohibited, instead of or in addition to the device name of the server device 1712 in which communication via the switch device 1711 is permitted. The setting file for the server device 1712 managed by the remote setting device 40 may be a setting file including the device name of the switch device 1711 connected to the server device 1712. Due to this, information setting regarding communication between the server device 1712 and the switch device 1711 and control of whether or not data transmitted and received by the server device 1712 passes through the switch device 1712 is easily performed.

When a 5G wireless network (or an LTE communication network) is constructed, it is desirable to construct a network slice in which the wireless network is logically divided in order to provide a communication service of a different quality (e.g., Quality of Service (QoS)). Due to this, data transmitted and received between the transmission source and the transmission destination via the wireless communication facility 90 is transmitted and received via any of the network slices. The remote management information may include a setting file defining information on the network slice in the wireless communication facility 90. In the setting file, a bandwidth, a priority, and the like guaranteed in each network slice are defined. In the facility configuration file, a packet relay device name and a virtual network identifier constituting the network slice are defined. According to the example illustrated in FIG. 17, upon receiving the setting file of the network slice from the remote setting device 40, the representative setting device 30 refers to the facility configuration file to confirm the packet relay device belonging to the network slice and the virtual network identifier thereof. Then, the representative setting device 30 sets the bandwidth, the priority, and the like defined in the setting file for the virtual network of these packet relay devices. In a case where a large value is described as a variable for each of the bandwidth and the priority in the setting file of the network slice, the representative setting device 30 performs setting for securing a large bandwidth for the communication interface device (e.g., a network interface card (NIC)) in the wireless communication facility 90 associated with the virtual network constituting the network slice. The representative setting device 30 performs setting for the communication interface device to perform priority control on packets transmitted and received in the virtual network. As described above, the network slice is provided with a communication service having a wider bandwidth and a lower delay than those of other network slices. There may be a setting file for each network slice. Setting contents for each of a plurality of network slices may be described in one setting file.

When a change occurs in any of the setting files managed by the remote setting device 40, the remote setting device 40 may transmit the setting file after change, which is the setting file in which the change has occurred, to the representative setting device 30. The representative setting device 30 may receive the setting file after change and set the information conforming to the setting file after change to the device in which the information conforming to the setting file before change is set. Due to this, if a necessary change is made to the setting file in the remote setting device 40, the information conforming to the setting file after change is set to the corresponding device in each wireless communication facility 90 having the device in which information conforming to the setting file before change is set. That is, the change can be automatically reflected in the device in the wireless communication facility 90.

The wireless communication facility 90 may include a sensor connected to at least one switch device in the wireless communication facility 90. The remote setting device 90 may update, for at least one of the plurality of devices, a setting file based on sensor information, which is information acquired from the sensor, or may specify a setting file corresponding to the sensor information, and transmit the updated or specified setting file to the representative setting device 30. The representative setting device 30 may set, to a device corresponding to the setting file, information conforming to the setting file. Due to this, it can be expected that the information set in the device in the wireless communication facility 90 is maintained as information optimal for the state estimated from the sensor information of the sensor in the wireless communication facility 90. In the above-described embodiment, a setting file appropriate for the state estimated from each piece of sensor information at one or more time points is specified, and the setting file is transmitted to the wireless communication facility 90, which is the transmission source of the sensor information. However, the following processing may be performed. That is, the remote setting device 40 may change the setting contents (description) of the setting file having been transmitted to the wireless communication facility 90 to setting contents suitable for the sensor information estimated from the sensor information from the wireless communication facility 90, and transmit the setting file after change to the representative setting device 30 of the wireless communication facility 90.

For each of the plurality of devices, when the representative setting device 30 detects activation of the device or when the representative setting device 30 is activated, the representative setting device 30 may acquire the device identifier of the device. Due to this, it is possible to automatically start setting in response to activation.

In a case where a wireless network is constructed for 5G (or 6G or LTE), it is preferable to provide a cooperation function with multi-access edge computing (MEC) in order to provide a low-delay communication service. Therefore, MEC equipment may be disposed as the data processing device 60 in the wireless communication facility 90. Upon recognizing IP address allocation information and the device configuration file in the wireless communication facility 90, the representative setting device 30 may describe the IP address of the MEC equipment into the device setting file in the wireless communication facility 90 and describe the IP address of the device in the wireless communication facility 90 into the device setting file for MEC.

Although the present disclosure has been described with reference to example embodiments, those skilled in the art will recognize that various changes and modifications may be made in form and detail without departing from the spirit and scope of the claimed subject matter.

What is claimed is:

1. An information setting system comprising:
a representative setting device that is a setting device not included in a plurality of devices in a wireless communication facility as a device package including the plurality of devices including one or more switch devices and a wireless base station, the representative setting device connected to at least one of the one or more switch devices; and
a remote setting device that is a remote setting device of the wireless communication facility, wherein
the remote setting device manages remote management information that is information including information indicating a correspondence relationship among a device identifier, a device name, and a setting object,
the device identifier is an identifier of a device,
the device name is a name of a device,
the setting object is an object representing information set in a device,
for each of the plurality of devices, the representative setting device acquires a device identifier of the device, allocates a network identifier to the device, includes the acquired device identifier and the allocated network identifier into representative management information that is information indicating the correspondence relationship between the device identifier and the network identifier, and transmits the device identifier to the remote setting device,
for each of the plurality of devices, the remote setting device receives the device identifier, specifies the device name and the setting object from the remote management information based on the device identifier, and transmits the device name and the setting object to the representative setting device, and
for each of the plurality of devices, the representative setting device receives the device name and the setting object, and sets information conforming to the setting object to the device to which the network identifier is allocated, based on the device identifier and the network identifier corresponding to the device name in the representative management information.

2. The information setting system according to claim 1, wherein
at least one setting object managed by the remote setting device is an update setting object that is a setting object including a device name with which a network identifier is associated, and
when a setting object corresponding to a device identifier of a device is an update setting object, the representative setting device specifies, from the representative management information, a network identifier corresponding to a device name in the update setting object, associates the specified network identifier with a device name in the update setting object, and sets information to the device in accordance with an update setting object with which the network identifier is associated.

3. The information setting system according to claim 2, wherein
the plurality of devices includes a connection device that is a device connected to at least one switch device,
an update setting object includes a setting object for a switch device and a setting object for a connection device,
a setting object for a switch device managed by the remote setting device is a setting object including at least one of a device name of a connection device in which communication via a switch device is permitted and a device name of a device in which communication via a switch device is prohibited, and
a setting object for a connection device managed by the remote setting device is
a setting object including a device name of a switch device connected to the connection device.

4. The information setting system according to claim 1, wherein
the remote management information includes one or more network slice setting objects that are one or more setting objects including information on a network slice for each of a plurality of network slices into which the wireless communication facility is logically divided,
data transmitted and received between a transmission source and a transmission destination via the wireless communication facility pass through any of the plurality of network slices, and
the representative setting device receives the one or more network slice setting objects from the remote setting device, and sets information on each of the plurality of network slices in accordance with the one or more network slice setting objects.

5. The information setting system according to claim 4, wherein the one or more network slice setting objects include information indicating a bandwidth and a priority of the network slice for each of the plurality of network slices.

6. The information setting system according to claim 1, wherein
when a change occurs in any setting object managed by the remote setting device, the remote setting device transmits a setting object file after change, which is a setting object in which the change has occurred, to the representative setting device, and
the representative setting device receives the setting object after change, and sets information conforming to the setting object after change to a device in which information conforming to a setting object before change is set.

7. The information setting system according to claim 1, wherein
the wireless communication facility includes a sensor connected to at least one switch device in the wireless communication facility,
for at least one of the plurality of devices, the remote setting device updates a setting object based on sensor information that is information acquired from the sensor or specifies a setting object corresponding to the sensor information, and transmits an updated or specified setting object to the representative setting device, and
the representative setting device sets information conforming to the setting object to a device corresponding to the setting object.

8. The information setting system according to claim 1, wherein, for each of the plurality of devices, when the representative setting device detects activation of the device or when the representative setting device is activated, the representative setting device acquires a device identifier of the device.

9. An information setting method, wherein
a representative setting device that is a setting device not included in a plurality of devices in a wireless communication facility as a device package including the plurality of devices including one or more switch devices and a wireless base station, the representative setting device connected to at least one of the one or more switch devices executes following (A) and (B),
(A) for each of the plurality of devices, acquiring a device identifier of the device, allocating a network identifier to the device, including the acquired device identifier and the allocated network identifier into representative management information that is information indicating a correspondence relationship between a device identifier and a network identifier, and transmitting the device identifier to the remote setting device,
the remote setting device is a remote setting device of the wireless communication facility and manages remote management information that is information including information indicating a correspondence relationship among a device identifier, a device name, and a setting object,
a device identifier is an identifier of a device,
a device name is a name of a device,
a setting object is an object representing information set in a device, and
(B) for each of the plurality of devices, receiving, from the remote setting device, a device name and a setting object specified from the remote management device based on a device identifier of the device, and setting information conforming to the setting object to the device to which a network identifier is allocated, based on the device identifier and a network identifier corresponding to the device name in the representative management information.

10. A computer program causing a representative setting device that is a setting device not included in a plurality of devices in a wireless communication facility as a device package including the plurality of devices including one or more switch devices and a wireless base station, the representative setting device connected to at least one of the one or more switch devices to execute following (A) and (B),
(A) for each of the plurality of 8 devices, acquiring a device identifier of the device, allocating a network identifier to the device, including the acquired device identifier and the allocated network identifier into representative management information that is information indicating a correspondence relationship between a device identifier and a network identifier, and transmitting the device identifier to the remote setting device,
the remote setting device is a remote setting device of the wireless communication facility and manages remote management information that is information including information indicating a correspondence relationship among a device identifier, a device name, and a setting object,
a device identifier is an identifier of a device,
a device name is a name of a device,
a setting object is an object representing information set in a device, and
(B) for each of the plurality of devices, receiving, from the remote setting device, a device name and a setting object specified from the remote management device based on a device identifier of the device, and setting information conforming to the setting object to the device to which a network identifier is allocated, based on the device identifier and a network identifier corresponding to the device name in the representative management information.
